(19) United States
(12) Patent Application Publication
(10) Pub. No.: US 2009/0280464 A1
(43) Pub. Date: Nov. 12, 2009

(54) SYSTEM AND METHOD FOR PROVIDING EDUCATIONAL CONTENT THROUGH GAMING OVER A NETWORK

(75) Inventors: Stephen B. CORN, Sharon, MA (US); Scott SEGAL, Chestnut Hill, MA (US); Rhoda CORN, Norton, MA (US)

Correspondence Address: LAHIVE & COCKFIELD, LLP;FLOOR 30, SUITE 3000, ONE POST OFFICE SQUARE, BOSTON, MA, 02109, US

(73) Assignee: QD Enterprises, LLC, Sharon, MA (US)

(21) Appl. No.: 12/388,494

(22) Filed: Feb. 18, 2009

Related U.S. Application Data
(63) Continuation-in-part of application No. 11/247,957, filed on Oct. 11, 2005, now Pat. No. 7,517,220.
Application No. 11/247,957 is a continuation of application No. 09/835,046, filed on Apr. 13, 2001, now Pat. No. 6,987,945.
(60) Provisional application No. 60/197,313, filed on Apr. 14, 2000.

(51) Int. Cl. G09B 7/00

(52) U.S. Cl. 434/350

(57) ABSTRACT

A method of distributing educational content over a network is disclosed. Educational content is divided into topics and the topics are split into smaller educational units. Professionals reviewing the material for accreditation purposes choose particular units to study and are subject to minimum and maximum time parameters. The partitioning of educational topics allows advertisers to deliver episodic advertising over an extended time period.

### RELATED APPLICATIONS

This application is a continuation-in-part of U.S. patent application Ser. No. 11/247,957, entitled “A System and Method for Providing Educational Content over a Network,” filed on Oct. 11, 2005, which is a continuation of U.S. patent Ser. No. 09/835,046, entitled “A System and Method for Providing Educational Content over a Network” filed on Apr. 13, 2001 (which claimed the benefit of U.S. Patent Application Ser. No. 60/197313, filed Apr. 14, 2000), and which is now U.S. Pat. No. 6,987,945 B2, the contents of all of which are incorporated by reference herein in their entirety.

### TECHNICAL FIELD

The present invention relates generally to systems and methods for conveying educational information and more particularly to a system and method for producing, publishing, and disseminating educational material for use by doctors, nurses, pharmacists, allied healthcare professionals and other professionals and students, both those in training and in practice.

### BACKGROUND OF THE INVENTION

Many professionals today are required and/or encouraged to receive continuing education in their particular field or discipline. Conventionally, this has been accomplished through the use of professional seminars and/or home study materials. Some professions, such as the medical profession, require their members to receive a certain number of hours of continuing education over a certain time period, such as every year, or every two years. Professions which have mandatory continuing education for their members, also have compliance entities to certify that members complete the education requirement. The verification procedures followed by these compliance entities vary with the category of continuing education required. For some categories of continuing education, the verification procedure may simply entail showing proof of attendance at a seminar. Other categories of continuing education require a seminar attendee or material reviewer to complete a quiz to be graded by a certifying authority.

### SUMMARY OF THE INVENTION

The embodiments of the present invention provide a mechanism for providing educational content over a network. Educational content is delivered in a manner that satisfies the compliance entities of professional organizations tasked with the job of determining member's compliance with continuing education requirements. Educational content is divided into topics and the topics are segregated or grouped into smaller educational units. The various educational topics are referenced on an initial web page run by the educational content provider. A professional visiting the initial web page selects an educational unit to review. Once selected, the professional may review the educational content subject to minimum and maximum time requirements designed to ensure participation in the education process. Failure to meet the minimum time requirement optionally results in a message to the professional that the professional needs to continue reviewing material in order to receive education credit that will satisfy the continuing education requirement. Failure to satisfy the maximum time requirement, i.e., exceeding the maximum time requirement, results in a message being sent to the professional that no educational credit will be granted for the review process.

In one embodiment, a method for providing educational content through gaming over a network provides a page having educational content delivered in the form of a playable game. A professional accrediting authority requires the review of the educational content by a user prior to the professional accrediting authority certifying the compliance of the user with a professional continuing education requirement. The method also receives a request for the page from a user and subsequently sends the page to the user. The method further receives an identified elapsed time from a computing device to which the page was sent. The identified elapsed time indicates the amount of time the user viewed the educational content while playing the game. Additionally, the method awards continuing education credit based on the elapsed time and pre-determined guidelines set by the professional accrediting authority. An indication of the awarded credit is stored at a location accessible to the professional accrediting authority.

In another embodiment, a computer-readable medium holds computer-executable instructions for providing educational content through gaming over a network. The instructions transmit a page having educational content over the network in response to a received request. The educational content is delivered in the form of a playable game that adjusts a game point total for a user based on correct and incorrect choices respectively made during gameplay. A professional accrediting authority requires the review of the educational content by a user prior to the professional accrediting authority certifying the compliance of the user with a professional continuing education requirement. The instructions also receive an identified elapsed time from a computing device to which the page was sent. The identified elapsed time indicates the amount of time the user viewed the educational content. A continuing education credit is awarded based on the elapsed time and pre-determined guidelines set by the professional accrediting authority. The award is separate from the game point total. An indication of the awarded credit is stored at a location accessible to the professional accrediting authority.

### BRIEF SUMMARY OF THE DRAWINGS

The accompanying drawings, which are incorporated in and constitute a part of this specification, illustrate one or more embodiments of the invention and, together with the description, explain the invention. In the drawings:

FIG. 1 depicts a network environment suitable for practicing an illustrative embodiment of the present invention;

FIG. 2 depicts a block diagram of the website of an educational provider practicing an illustrative embodiment of the present invention;

FIG. 3 is a flow chart of an exemplary sequence of steps followed by a user to review educational content in the present invention;

FIG. 4A is a flow chart of an exemplary sequence of steps followed by an embodiment to provide educational content to a user via a playable game;

FIG. 4B is an exemplary graphical user interface for the game of FIG. 4A;

FIG. 5 is a flow chart of an exemplary sequence of steps of a method of providing sequential advertising in an illustrative embodiment of the present invention;

FIG. 6 is a depiction of a graphical user interface used in an illustrative embodiment of the present invention at the beginning of the educational content review process; and

FIG. 7 is a depiction of a graphical user interface used in an illustrative embodiment of the present invention at the end of the educational content review process.

### DETAILED DESCRIPTION

Before we begin, we provide below some definitions.

The term professional is used herein to include, without limitation, any person whose professional work is based on a significant or specialized body of knowledge or work experience, such as attorneys, doctors, nurses, engineers, accountants, airplane pilots, factory workers, seamstresses, and the like. A non-professional is someone who is not considered to be a professional.

A network is a facility that interconnects a number of devices and provides a means for transmitting data from one attached device to another. The term network is used broadly herein and is used to refer to intranets, extranets, IP networks, and the like.

A page is a storage container/structure designed to hold content. A page designed to be accessed over the Internet is called a web page.

Content (educational content) refers to media content or data such as text, graphics, images and multi-media objects such as sound recordings and moving video clips, as well as executable content such as software code. The educational content may be displayed to a user in many different formats such as question and answers, puzzles, and other formats.

The term educational unit as used herein is intended to include content of an educational, advisory or explanatory nature, such as content directed to an educational topic. The educational unit is sized and arranged to be reviewed or studied by itself or in conjunction with other educational units. The educational units are substantially complete parcels of information or content that do not require referral to external resources. For example, the educational unit can contain information pertinent to a particular subject, such that when reviewed, conveys all necessary information for understanding the subject to the user. Alternatively, the educational unit can control the content size by providing links to other information. The use of links is intended to be encompassed by the educational unit, and still forms a complete content package. The educational units are considered capable of being received alone, and preferably content that is meaningful, beneficial or important to a user. The educational units may be sized for transfer to computing devices with limited memory. One or more educational units may be combined to form a topic.

The term advertising unit as used herein is intended to include parcels of advertising content or information. The advertising unit can include a total, complete advertisement or part of an advertisement. If the educational unit includes only a part of an advertisement, the advertising unit can be viewed or associated with other advertising units, and particularly units that form a complete advertisement. The advertising unit, although complete, can also be viewed or associated with other units to form a larger advertisement or advertising topic. Hence, although each unit is a stand-alone, complete unit, it can be associated with other advertising units. According to one practice, an advertising unit can be indexed or associated with one or more educational units and displayed in connection therewith.

The term computing device as used herein refers to devices capable of executing computer instructions, interfacing with the network, and in some embodiments possessing an internal clock. The computing device may be a desktop computer system, personal digital assistant (PDA), handheld wireless device, cellular phone, pager, laptop or other similar device. A client device refers to a computing device holding a subservient position in a distributed server-client relationship.

The growth of the Internet has led to new methods of providing educational content to people. “Distance learning” or “remote education” are terms used to describe the provision of education over the Internet. Conventionally, distance learning providers receive certification from professional organizations, which allows them to provide continuing professional education, by maintaining a testing requirement for those types of education that require a professional to materially participate in the educational process. Unfortunately, the current testing component required by conventional continuing education providers is inefficient and unwieldy. A method is needed whereby compliance entities may be satisfied that professionals have materially participated in the continuing education process and yet does not require the professionals to undergo testing in order to prove that participation.

Embodiments of the present invention provide a method of delivering educational content over a network. Educational content may be delivered in a manner that satisfies continuing education compliance entities of professional organizations which are tasked with the job of determining member compliance with continuing education requirements. Educational content can be divided into topics and the topics can be segregated or grouped into smaller educational units so that professionals may study educational units of a manageable size. Topics are naturally occurring groupings of information recognizable to a professional in the field of study (as opposed to courses, which are collections of educational units assigned by an educational provider). The educational units are intended to include content of the type that is substantially complete so that it can be considered alone without needing to consider external resources by a professional or a non-professional. The educational unit can contain content that is meaningful or beneficial to the user. The term “meaningful” as used herein is used to convey the concept that the reviewed content is important to the particular user. Because the content of a single educational unit is complete, professional accrediting entities are willing to extend continuing education credit for reviewing single units. Since the educational units can be portions of a larger educational topic, there is an increased likelihood of repeat visits by professionals as the professionals endeavor to complete an entire topic. This likelihood of repeat visits allows an advertiser to deliver advertising in units over time as the user works their way through a topic. The ability to deliver advertising units or topics over time allows episodic or sequential advertising directed to repeat users, and preferably associated with related educational units. The advertising units being delivered may be matched to an educational content request.

The systems and methods of delivering educational content over a network discussed herein utilize computer applications which are known as web browsers. Web browsers, such as Netscape Navigator, from Netscape Communication Corporation, of Palo Alto, Calif., retrieve web pages and execute content (if any) contained in the web pages. The web pages are usually stored on a web server accessible over a network. The web pages are written in a markup language, such as the Hypertext Markup Language (HTML) or the Extensible Markup Language (XML) and contain information which is interpreted for display to a user by the web browser.

Many of the documents available on the Internet today are stored in HyperText Markup Language (HTML) or eXtensible Markup Language (XML). HTML is a markup language that encodes a document via the use of tags and attributes. Tags appear between < > brackets, and attributes are specified in the form of “name=value”. HTML specifies the meaning of each tag and attribute and how text located between tags and/or attributes will appear. An example is a tag <p> which designates the beginning of a new paragraph. A corresponding tag </p> designates the end of the paragraph. HTML documents are typically interpreted by HTML interpreters found in web browsers. XML is similar to HTML but allows greater flexibility through the use of customized tags. Web browsers equipped with XML interpreters are required to translate and present web pages written in XML.

Conventionally, a user launches a web browser on an electronic client device in order to view web pages over a network. The web browser may be part of an application suite, such as Netscape Communicator, from Netscape Communications Corporation, or it may be a stand-alone application such as Netscape Navigator. The browser retrieves the web page, interprets it, and displays it to a user. While interpreting the web page, the browser may encounter an indication of an embedded “applet”. The indication is a tag “<applet>”. An “applet” is a program designed to be executed from within another application. Applets enable web pages to include advanced effects, such as moving graphics and sound. Applets may be written in a multitude of languages, but many applets are written in JAVA (JAVA is a trademark or registered trademark of Sun Microsystems, Inc. of Palo Alto, Calif. in the United States and in other countries) JAVA is an object oriented language specifically developed to provide cross platform capability. The JAVA software architecture is designed to support platforms ranging from personal computers to embedded network devices. Web browsers which are equipped with JAVA virtual machines (JVMs) can interpret the JAVA applets.

Once the web browser interpreter encounters a JAVA applet, the browser retrieves the code for the applet from an indicated source. The source for the applet may be the original location of the web page, which is often a web server. Alternatively, the source may be a different remote source accessible over the network for which a uniform resource locator (URL) address is provided. The retrieved code is fed to the JVM for execution. The result of the code execution may (in some instances) be shown by the web browser in the display presented to the user. This embedding of code enables whole programs to be included within a single web page merely by including a small applet to indicate the code source.

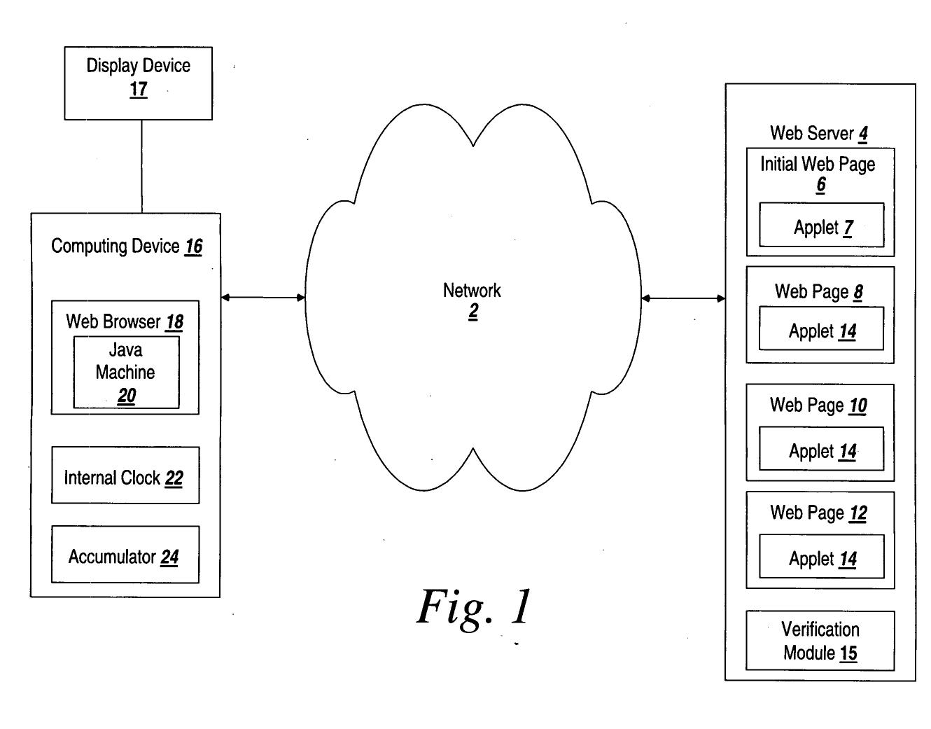

FIG. 1 depicts a network environment suitable for practicing an illustrative embodiment of the present invention. A web server 4 communicates over a network 2 with a computing device 16. The web server 4 includes an initial web page 6 which includes references to other web pages holding educational content 8, 10, and 12. The initial web page 6 includes an applet 7 which, when executed, retrieves the address of the site the web browser visited immediately prior to retrieving the web page. The retrieved web address may be compared against the addresses of the other web pages holding educational content 8, 10, and 12. If the retrieved address matches the web address of one of the other web pages 8, 10, and 12, the address is cross-indexed against a list of advertisements to determine which advertisement unit to display to the user. The other web pages 8, 10, and 12 on the web server 4, include educational content and an applet 14 which causes a retrieving electronic client device to start an internal clock and track the amount of time a user of the computing device spends reviewing the web page.

The web server 4 may also host or communicate with a verification module 15. The verification module 15 is a software process which compares a tracked elapsed amount of time a user spent reviewing the educational content retrieved from the web server against pre-defined criteria in order to determine whether the awarding of continuing education credit is appropriate. As discussed further below, the tracking of the elapsed time is performed locally on the computing device 16 requesting the educational content and the total elapsed time is transmitted back to the web server 4 to be analyzed by the verification module 15. It should be appreciated that although the verification module 15 is depicted as being hosted by the web server 4, the verification module may also be located remotely from the web server at another location accessible over a network.

Also interfaced with the network 2 is the computing device 16 which includes a web browser 18 with an associated JAVA Machine 20. The computing device 16 may be a desktop computer system, PDA, handheld wireless device, laptop or other device possessing an internal clock and interfaced with the network 2. The computing device 16 includes an internal clock 22 capable of independently tracking time, and an accumulator 24 capable of storing data such as the elapsed amount of time. The accumulator 24 may be located in any memory location accessible to the computing device 16. Those of ordinary skill will readily recognize that the clock can be located anywhere in the network. The term clock as used herein is intended to include any structure capable of tracking or determining time. Those skilled in the art will recognize that the network 2 may include the Internet, a wide area network (WAN), a local area network (LAN) or some other type of network. The physical media used in the network may be telephone line, Ethernet cable, fiber-optic cable, or the network may be a wireless network. The computing device 16 is in communication with a display device 17 upon which the web pages 6, 8, 10 or 12 that are retrieved from the web server 4 may be displayed.

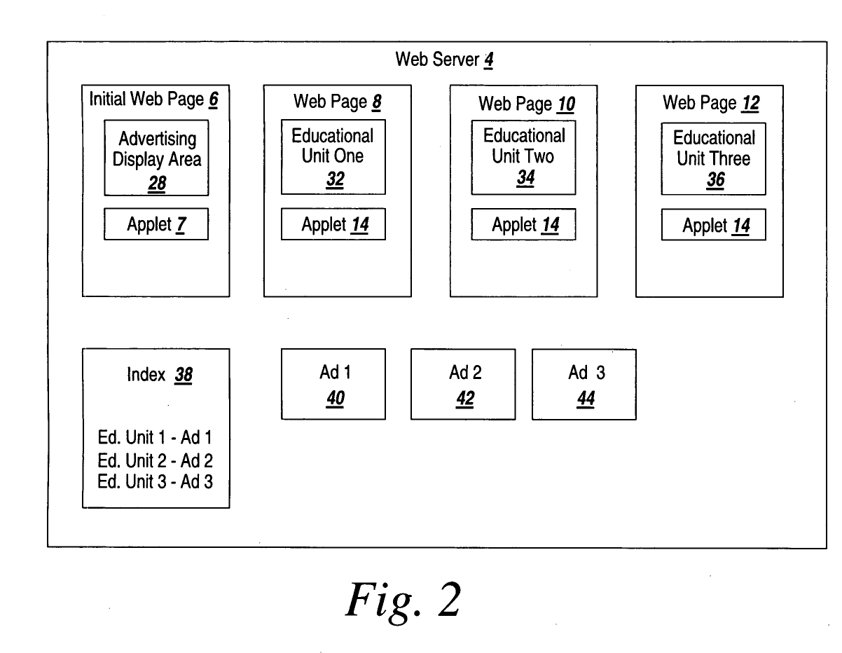

The educational content which is retrieved for review is stored on web pages. FIG. 2 depicts a block diagram of an illustrative embodiment of the present invention which includes a web server 4 hosting a plurality of web pages holding educational content. The web server 4 includes an initial web page 6 and additional other web pages 8, 10, and 12 holding educational content 32, 34 and 36. The initial web page 6 acts as the entry into the educational website from locations outside the web server 4 and includes an advertising display area 28. The advertising display area 28 allows an advertiser to display an advertisement to the user of the computing device 16 when the web page is retrieved via the web browser 18. Each of the web pages 8, 10, and 12 holding educational content 32, 34, and 36 include an applet 14 which is executed by the retrieving web browser 18 and causes the retrieving computing device 16 to start its clock 22. The clock 22 is used to track the amount of time a user of the computing device 16 takes to review the educational content 32, 34 and 36. The elapsed amount of time is used by embodiments of the present invention to determine whether to grant continuing education credit from professional organizations and is discussed in more detail below. As noted above, when the initial web page 6 is retrieved by a user of a computing device 16 and the applet 7 is executed, the applet on the initial web page determines whether the browser is retrieving the web page immediately after the user viewed an educational unit. If the previous address in the retrieving web browser 18 matches one of the web pages holding educational content 8, 10, and 12, the applet 7 consults an index 38 stored on the web server 4. The index 38 links an advertisement unit to one or more educational units. The advertisement units can be different for selected ones of the educational units. In some embodiments, the advertisements 40, 42, 44 are located on the web server 4. In other embodiments, the advertisements 40, 42, 44 may be located remotely to the web server 4 at a location accessible over the network. An advertisement linked to an educational unit is displayed on the advertising display area 28 on the initial web page 6. If the previous URL address of the retrieving web browser is not one of the other web pages 8, 10, and 12 hosted by the web server 4, a default advertisement is displayed in the advertising display area 28. Those skilled in the art will recognize that the index 38 may be stored either locally or at a remotely to the web server 4.

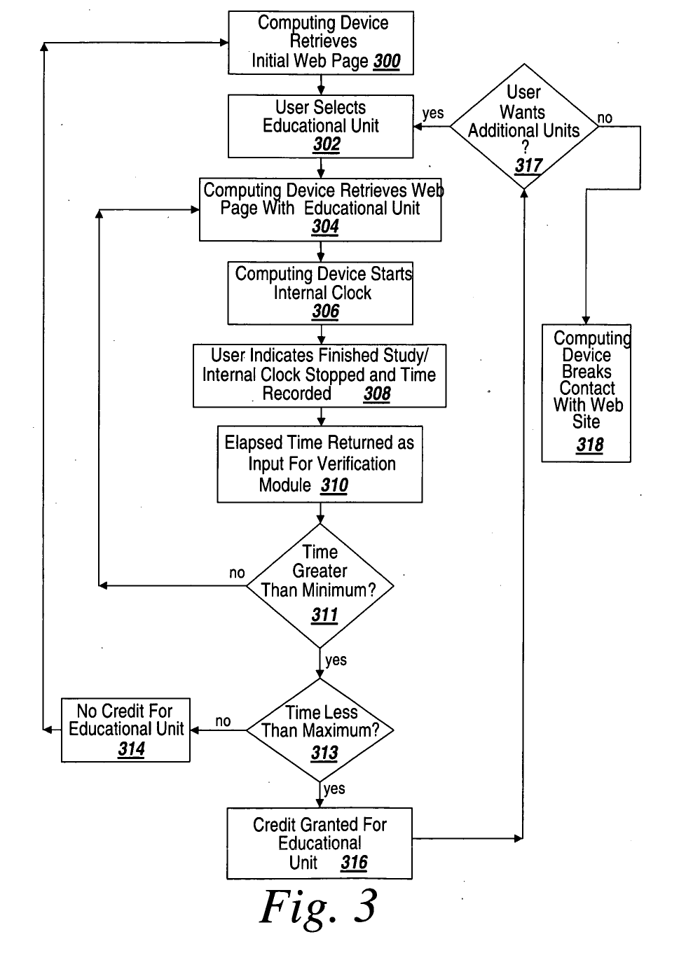

FIG. 3 depicts the sequence of steps followed in an illustrative embodiment of the present invention. The sequence begins when a computing device retrieves the initial web page 6 stored on the web server 4 (step 300). The initial web page 6 includes links to other web pages 8, 10, and 12 which contain educational content 32, 34, and 36. The educational content 32, 34 and 36, on the web pages 8, 10 and 12, corresponds to individual educational units which constitute part of, or the entire topic. The user, if desired, can select the educational unit they wish to review (step 302). The web page holding the educational unit is retrieved by the user via the network 2 (step 304). If the user desires to obtain educational credit from an accrediting entity, the user logs in via dialog boxes and a login button. The process of logging in starts an applet which in turn causes the computing device 16 to start an internal clock (step 306). The start time is stored in an accumulator 24. Those skilled in the art will recognize that while JAVA applets are used for the purposes of illustrating the embodiments described herein, any sort of computer-executable code causing a retrieving computing device to start and stop an internal clock would be sufficient for the purposes of the present invention.

The user of the computing device indicates they have finished reviewing the educational content contained in the retrieved web page by logging out via dialog boxes and a logout button (step 308). Those skilled in the art will recognize that other forms of graphical user interfaces or non-graphical based procedures may be used for the login and logout processes without departing from the scope of the present invention. The act of logging out causes the internal clock to stop. The stop time is compared against the start time to determine an elapsed time. The elapsed time is returned to the computing device that supplied the educational content as input for the verification module 15. (step 310) The elapsed time amount is checked by the verification module 15 against a minimum time parameter (step 311). If the elapsed time the user spent studying or reviewing the educational content does not exceed the minimum time parameter, the user is sent a message that further review is required and is returned to the educational unit web page (step 304). Any additional time spent reviewing the web page is tracked using the internal clock 22 and the accumulator 24. Subsequently, the user may again indicate the completion of their review and return to the initial web page with a new elapsed time (step 310).

If the elapsed time is greater than the minimum time parameter (step 311) the accumulated time is checked against a maximum time parameter also stored on the web server 4 (step 313). If the user has exceeded the maximum time parameter the user of the computing device 16 is sent a message indicating that no credit for their educational unit review will be granted (step 314) and the user of the computing device is returned to the initial web page (step 300). If the elapsed time is greater than the minimum time parameter and less than the maximum time parameter (step 311 and step 313) the user is sent a message indicating that credit will be granted for the educational unit (step 316). The user of the computing device 16 may wish to review more educational content (step 317), in which case the user will select an additional educational unit from the initial web page (step 302). If the user of the computing device does not want to review additional educational content (step 317) the user clicks the appropriate graphical user interface on the initial web page 6 and the computing device 16 breaks contact with the web server 4 (step 318). Those skilled in the art will recognize that the minimum and maximum time parameters may be stored in other locations than the web server 4 as long as the locations are accessible over the network 2.

The time parameters and educational unit size play a central role in the embodiments of the present invention. The minimum time parameter prevents a user of the computing device from rapidly clicking their way through screens to satisfy an educational requirement. The maximum time parameter prevents a user from clicking on to a site and then turning their attention to other matters for extended periods of time before returning to their computing device 16 and indicating that they had been studying for the entire time. The maximum time parameter combines with the division of educational topics into smaller educational units to help ensure that the user is actually at their computing device or considering the displayed educational unit. The small size and completeness of the educational unit provides a means for the professional or non-professional to learn in a convenient time efficient environment over a day, or over many non-contiguous days throughout the course of a year, while concomitantly earning continuing education credit (in the case of the professional). It is this manner of verifying that users are materially participating in the educational process that allows accreditation authorities to extend continuing education credit without a testing requirement.

The educational units may be presented in many different formats to a user. In one format, the educational content 32, 34 and 36 is presented in the form of an interrogatory, such as “The Question of the Day”. After a user has pondered the question for a sufficient amount of time, they may request the answer by clicking on a graphical user interface in order to be presented with the answer. Both the time spent reviewing the question and reviewing the answer are considered for accreditation purposes. A significant advantage of providing the posted educational content in a question format is that it allows the user to consider the appropriate response to the question, in order to invoke a thoughtful response to the posted question. Another significant advantage of the educational content format of the invention is that it can be divided into independent and separate discrete educational units, in the form of a question and corresponding answer, which can form part of a larger set of questions or complete educational units, to form a course. However, the completeness of each educational unit still provides meaningful educational content to the user who does not wish or desire to take the entire course.

The structure of each question and answer offers a subtle means of teaching. Each question and answer is written to appeal, for example to all levels of professional and non-professionals, such as the junior doctor, lawyer, commercial airline pilot, as well as the seasoned expert in each specialty. For example, in an educational unit on Anesthesiology, the daily question and answer typically is structured so that the beginning answer(s) contain(s) basic keywords and definitions. These keywords and definitions comprise a significant portion of the American Board of Anesthesiologists Specialty Examination for board certification. As a result, the junior resident learns and is interested by the question and answer format, since it provides a complete content package without necessitating reference to external resources. To educate the seasoned clinician, the question and answer typically concludes with a comparison of studies, a counter-intuitive fact, or a recent study questioning, augmenting, or updating traditional teaching. As such, each educational unit, due to its complete structure, is a valuable educational and advertising tool to interest the brand-new clinician through the seasoned professor.

The educational units can include, for example, a questions and answers format designed to cover content of a specialty or sub-specialty and can employ specific keywords for that specialty, as a guide to subject areas. Each question and answer (e.g., unit) is a stand-alone informational unit of value. However, the sum of the units is of additional value, since the sum of the parts can comprise a review course in a particular specialty, thereby earning additional continuing education credit. As such, stand-alone information (such as a daily Question of the Day) is packaged, over time, to create an added value. The daily question and answer are not created by simply dividing up lectures, video presentations or the like. Each days question and answer is a unit of meaningful complete informational content that can stand alone as a valuable educational tool. The units are also configured so that when grouped, they create a review course in a medical or other specialty or area, covering the content as so prescribed by the specialty board of that specialty (if applicable).

In another embodiment, the educational content may be presented in the form of a crossword puzzle. The crossword puzzle or similar “game” is available every day of a week (or other time interval) and corresponds to that week's educational format or syllabus (or other part of the syllabus). As the week progresses, the clues to the crossword puzzle become active links (hyperlinks) to the appropriate day's questions and answers. As such, a reader trying to complete the daily portion of the puzzle, when “stuck”, clicks on the available link to the answer. The puzzle feature also leads to many readers recruiting the assistance of their colleagues in an effort to solve the puzzle. This serves as a subtle, yet significant novel and unique advertising method for the educational site. Readers can use their personal password and personal page so that the answers completed are held in their personal puzzle(s) and the user can later retrieve in the puzzle. Completed puzzles can also be used as verification of site usage for credit. This interactive game feature encourages a user to continually access the educational system to review the educational content or to complete the educational game. This multiple return usage feature or requirement allows the user's performance and habits to be tracked. The information attained from this tracking can be employed to tailor advertising more specifically to the individual user, or to expose the user more frequently to the sponsor's advertisements or advertising units.

As previously noted, the content may also be presented as other types of games in addition to crossword puzzles. The content may be structured as a game such that navigating the game results in an educational experience. The game may be combined with the timing mechanisms discussed above such that the amount of time playing the game is tracked and can form the basis of continuing professional education credit being extended by professional accrediting authorities.

For example, in one embodiment, after logging in, a user may be presented with a question representing an educational unit as well as a number of possible answers graphically represented as doors or other objects. The user may pick one of the doors as the potential answer to the question. If the door represents the correct answer, a more embellished answer to the original question that provides additional detail may be displayed. In an additional aspect of the game points may be optionally awarded for correct answers (the awarding of game points is independent of the awarding of continuing education credit which is time-dependent). If an incorrect answer is chosen, a user may be presented with additional clues or directions (in the form of additional discussion of the content from the original question). This helps ensure coverage of the content which the original question was based upon. Additionally, points may be deducted for wrong answers. Alternatively, or in addition, the user may be informed that the answer was incorrect and told to guess again. Once the correct answer is found, the user may sign out to complete the time for that educational unit and the time spent playing the game may be compared to the minimum and maximum time parameters previously discussed.

The gameplay in the embodiments of the present invention thus facilitates the goals of continuing education providers to ensure that players are truly studying the questions and answers being presented. The gaming system discourages guessing by subtracting game points while giving clues to correct answers embedded within incorrect answers when the player is reading wrong answers thereby ensuring the material is reviewed (for continuing education purposes). Guessing to solely increase points and CME credit is discouraged by structuring the game so that an incorrect answer has information which leads to a correct answer. This inclusion of the information with the incorrect answers encourages the actual reading of the content so that both the correct and incorrect answers provide additional knowledge to the user. The underlying goal of continuing education and the reason for continuing education requirements, the dissemination of knowledge, is therefore met by the game in a manner in which continuing education providers can have confidence.

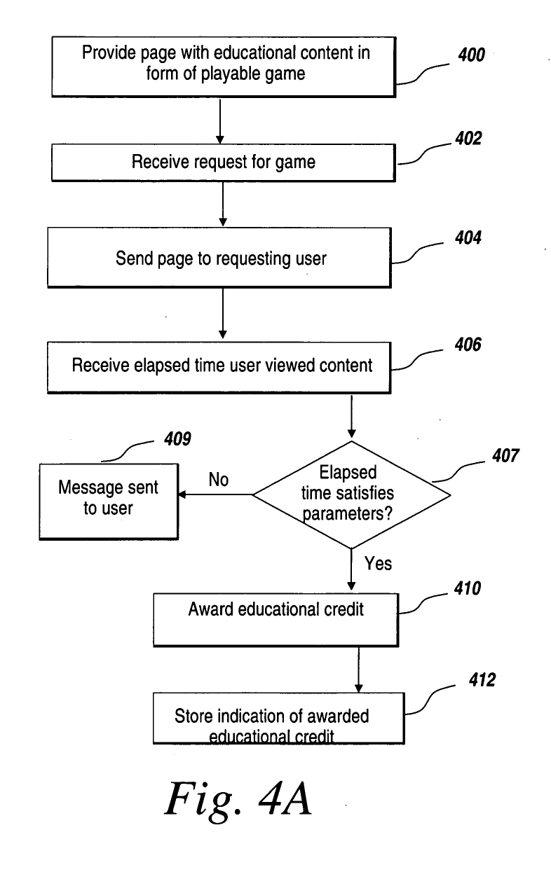

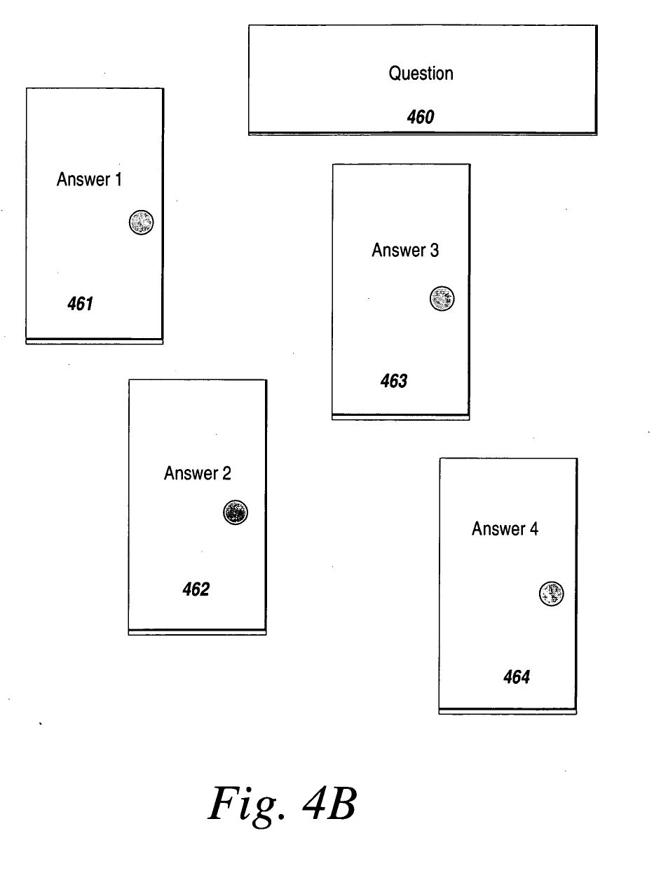

FIG. 4A depicts an exemplary sequence of steps that may be followed by an embodiment of the present invention to provide educational content. The sequence begins with a content provider providing a web page with educational content in the form of a playable game (step 400). The server hosting the game receives a request for the page which includes the game (step 402) and provides the page to the requesting user (step 404). Subsequently the elapsed amount of time the user spent viewing the educational content by playing the game is received (step 406). The elapsed time is analyzed (step 407) to determine if it satisfies the parameters of the professional accrediting authority. If it does not, a message explaining the insufficiency may be sent to the user (step 409). If the elapsed time does satisfy the time parameters (e.g. minimum and maximum time parameters), educational credit may be awarded (step 410). An indication of the amount of educational credit may then be stored (step 412).

FIG. 4B depicts an exemplary graphical user interface that may be used by a game where possible answers to a posed question are graphically depicted as doors. A question 460 may be posed to the user after the user logs in and possible answers may be represented as doors from which the user is expected to select the correct answer. For example, answer 1 may be depicted by a first door 461, answer 2 may be depicted by a second door 462, answer 3 may be depicted by a third door 463, and answer 4 may be depicted by a fourth door 464. Upon selection, the door may “open” and confirm the choice and provide additional detail. Alternatively, the door may “open” and indicate the user/player has selected incorrectly and provide additional hints which the user may study to make his or her next selection of an answer.

In another embodiment, rather than focusing on a single question the game may allow a user to sign up for a specified time period in which to review educational material. After selecting the time period, the user may log in and attempt to accumulate points during the time period by answering questions in a game. Correct game choices may generate a positive number of points in the game. Incorrect game choices may generate a negative number of points or a loss of time in order to keep a player from guessing and to encourage a player to review any additional information presented following an incorrect choice before making an additional selection. At the end of the selected time period, the points may be compared to a parameter to see if the user/player is eligible for continuing education credit. Alternatively, the points may only be for game use and may be irrelevant to the decision on whether to grant continuing education credit which may be based solely on the time spent reviewing the educational material in the game.

The points accumulated in the game may be used for other uses as well. For example, the points may be used for competition against oneself, another individual or between teams of individuals. The points may also be used to achieve educationally related gifts, prizes etc. that could be supplied by the host site or by an advertising company or sponsor.

Instead of the door motif described above, the game may utilize other graphical representations such as boats, sports equipment, hospital wards, courtrooms, etc. which may be either static or customizable by the user. For example, the game could utilize a beach theme, where the choices are represented by beach balls and scores are displayed on beach sand, etc. It will be appreciated that many other graphical representations are also within the scope of the present invention and that the time-based verification techniques discussed herein may also be applied to other public domain or licensed games.

Embodiments of the present invention allow interested users to return to the site to participate in any selected number of educational units (e.g., questions) whether presented in a game or other format. As a result, the web page displaying the content can also display advertising programs where the advertising sponsor can also meter or parcel the advertisement over any selected period of time in the form of advertising units. For example, the system can dispense the advertising units in parcels of information over days to months, as a result of being coupled to a particular one or group of educational units.

A different embodiment may present the educational content in outline form with hyperlinks to other web pages. Nonetheless, each educational unit still forms a unit having stand-alone, complete, self-contained content. Those skilled in the art will recognize that there are a number of different ways to present educational content to a user that are encompassed by the present invention, and that the educational content for a single educational unit is not necessarily restricted to being located on a single web page.

The educational content and web page advertisements may be sent to another professional or non-professional in order to expand the number of users reviewing and receiving the educational content. Embodiments of the present invention afford the user the ability to forward advertising content in addition to the educational content to a number of different people. A graphical user interface on one of the web pages holding educational content allows a user to forward the web page (content and advertising) to another computing device. The size of the educational unit facilitates the dissemination thereof to the device. If the educational content and accompanying advertisement are sent by electronic mail, the recipients email address may be recorded and stored for later use.

The division of educational topics into smaller educational units stored on separate web pages affords the advertisers on an educational website greater flexibility. The advertisers may present sequential advertisements to users of the website with the knowledge that the website users are likely to return for additional educational units. In other words, if an educational topic has been split into multiple educational units, it is likely that the user reviewing the educational content will return to the website multiple times in order to review all of the educational content for the particular topic. Because the user repeatedly returns to review the web page content, the system can display the advertising units in a sequential manner.

The relatively small size of the educational units has the additional benefit of enabling transfer of the web pages holding educational content to small capacity client devices. Client computing devices which are able to interface with the network 2 are able to download educational units even if they have limited memory storage space available. Advertisements are limited to a certain size to maintain this benefit. Thus handheld and other wireless devices may be utilized in the present invention.

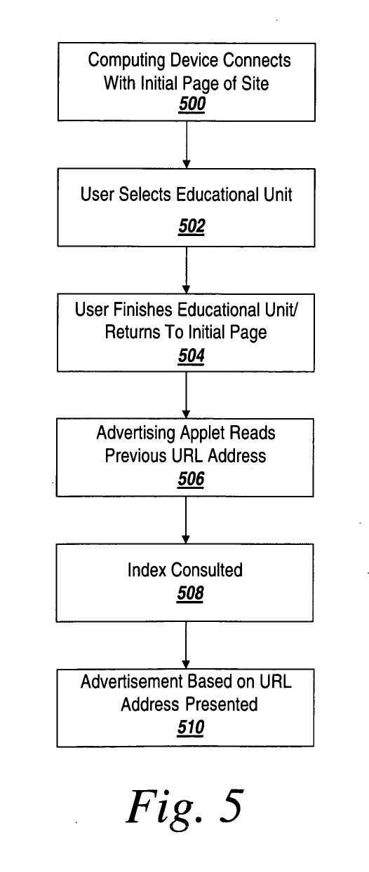

FIG. 5 depicts a flow chart of the sequence of steps by which an advertiser on an educational website is able to present sequential advertisements. The user of a computing device 16 retrieves an initial web page 6 of an educational site (step 500). The user of the computing device 16 selects an educational unit to review (step 502). When the user finishes reviewing the educational unit, the user is returned to the initial web page (step 504). An applet 7 stored on an initial web page 6 reads the previous URL address of the web browser 18 to determine where the web browser has been immediately prior to the initial web page (step 506). If the previous URL address retrieved from the web browser 18 indicates that the user of the web browser has just finished visiting a web page holding an educational unit, the URL address is reconciled against an index 38 which cross references educational units with specific ads (step 508). An advertisement based on the educational unit just reviewed is then displayed to the user (step 510).

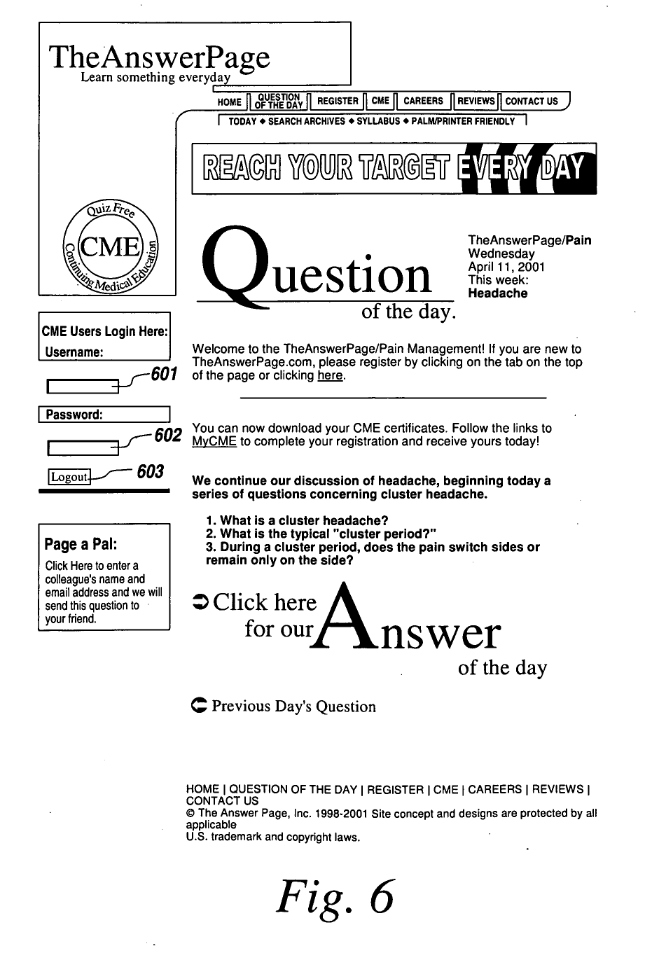

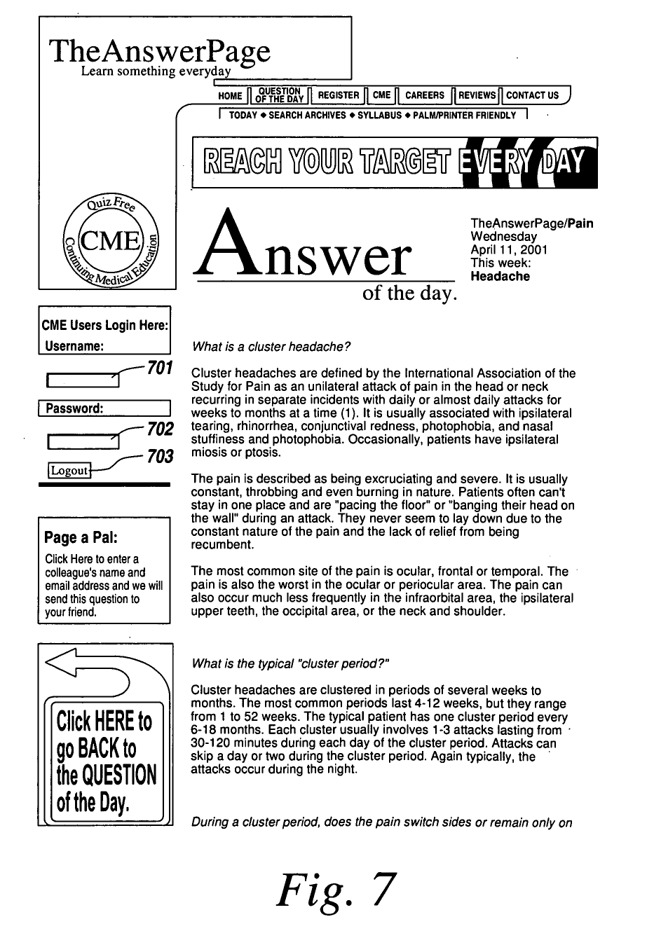

In one embodiment, when a professional wishes to receive educational credit for reviewing educational content the user logs in using dialog boxes and a login button on a retrieved web page. The login button starts an internal clock on the computing device which is used to track elapsed time. A logout button stops the clock. An applet on the web page reports the accumulated time to the educational provider for the determination as to whether applicable time parameters have been met. FIG. 6 depicts a web page including dialog boxes for a Username 601 and Password 602, and a login button 603. FIG. 7 depicts a web page including dialog boxes for a Username 701 and Password 702 and a logout button 703.

In an illustrative embodiment of the present invention, a search method is provided for the education content listed in the various educational units. The initial web page 6 employs content arranged in a selected manner that enables a user to search through stored web pages 8, 10 and 12 based on particular user-defined content. For example, the user may search educational units based on the profession of the authors of the educational unit. The search may include dates that allows a user to define particular start and end dates between which a search can be conducted. Alternatively, the search may be made by a particular specialty area or question category. Particular search boxes may be used to allow a user to define a syllabus topic, question content, answer content, or reference content.

The user may also search an archive of previous questions by topic, text in the question or answer, or by the references. The search also allows the user the ability to broaden a search to retrieve questions and answers from other educational units stored on other web page. For example, an obstetrician interested in a disease may be interested in the anesthetic implications of this disease. The user can search for a selected key word on multiple specialty sites (selectable by the user) without navigating to other web sites (e.g., URL addresses). This search feature enables the user to seek data usually directed at other professionals whenever necessary.

In one embodiment, the educational system disclosed herein generates an educational content inquiry at a selected, pre-determined, or random frequency. According to one practice, the educational system can create a daily inquiry that provides for (1) educating professionals and students, (2) separate and distinct educational parcels or units, and (3) supplying continuing education to professionals and non-professionals. The discrete educational units can be compiled or combined to form a course of selected length and duration.

If a user desires to complete a course, which is comprised of a selected number of educational units, the user must complete at least a selected number of the total number of educational units. The user's participation in the course, the frequency and duration of visits, as well as other user and system parameters, may be used to determine when and if the user completes the course. The user may be notified when the appropriate number of educational sub-units are completed. The reader may then be notified that if he or she submits payment, he or she will receive credit for a number of hours of continuing education credit. This is a novel educational means of supplying continuing education credit in daily parcels (contiguous or not) and a novel business means of inducing a reader to pay for something of significant value for that reader, that he or she has already earned but is under no obligation to pay for.

Each educational unit may be a stand-alone informational unit of value. However, the educational sub-units may be cumulatively employed to add or create additional value, since the sum of the parts comprises a review course for which credit can be allotted. As such, stand-alone information (daily Question of the Day) is packaged, over time, to create an added value. The daily educational content question and answer are not created by simply dividing up lectures, video presentations or the like. Each educational content question and answer is a parcel of information that can stand alone as a valuable educational tool. However, the parcels are so designed, that when grouped, they create a review course in a particular specialty.

Each educational unit may be configured to appeal both to professionals or non-professionals. The content may be structured so that the initial answers to the questions contains basic keywords and their definitions, which can be utilized by the user when studying or training to pass selected certifications or examinations. On the other hand, the questions may appeal to the more experienced professional by employing content directed to a comparison of studies, a counter-intuitive fact, or a recent study questioning, augmenting, or updating traditional teaching. As such, each educational unit due to its internal structure is a valuable educational and advertising tool that is focused and interesting to professionals of all levels and to non-professionals.

In one embodiment of the present invention, using the educational unit question and answer format, the user may supply answers to the daily question. The user's answers may be used to generate a user profile that is updated periodically, giving that user immediate feedback regarding performance. This educational model allows the user to focus attention on specific weaknesses or strengths. The educational units may be altered based on the user profile.

In an embodiment of the present invention, user-provided information is used to shape the content of subsequent educational units. A user completing an educational unit may respond via a dialog box or other graphical user interface about the just completed unit. The educational unit author may take this user-provided information into account for subsequent educational units. This prompt effect on course curriculum is absent in many continuing education programs.

The present invention may be provided as one or more computer-readable programs embodied on or in one or more physical mediums. For example, the mediums may be a floppy disk, a hard disk, a compact disc, a digital versatile disc, a flash memory card, a PROM, an MRAM, a RAM, a ROM, or a magnetic tape. In general, the computer-readable programs may be implemented in any programming language. Some examples of programming languages that can be used include C, C++, C#, Python, FLASH, JAVASCRIPT, or JAVA. The software programs may be stored on, or in, one or more mediums as object code. Hardware acceleration may be used and all or a portion of the code may run on a FPGA, an Application Specific Integrated Processor (ASIP), or an Application Specific Integrated Circuit (ASIC). The code may run in a virtualized environment such as in a virtual machine. Multiple virtual machines running the code may be resident on a single processor.

It will thus be seen that the invention attains the objects made apparent from the preceding description. Since certain changes may be made without departing from the scope of the present invention, it is intended that all matter contained in the above description or shown in the accompanying drawings be interpreted as illustrative and not in a literal sense. Practitioners of the art will realize that the network configurations depicted and described herein are examples of multiple possible network configurations that fall within the scope of the current invention. The network configurations are intended to be illustrative and not definitive. Likewise, the sequence of steps utilized in the illustrated flowcharts are examples and not the exclusive sequence of actions possible with the present invention.

The scope of the invention is defined by the claims and their equivalents.

We claim:

1. A computer-readable medium holding computer-executable instructions for providing educational content through gaming over a network, the instructions when executed by a computing device:
providing a page having educational content over the network, the educational content delivered in the form of a playable game, a professional accrediting authority requiring the review of the educational content by a user prior to the professional accrediting authority certifying the compliance of the user with a professional continuing education requirement;
receiving a request for said page from a user;
sending said page to the user;
receiving an identified elapsed time from a computing device to which the page was sent, the identified elapsed time indicating the amount of time the user viewed the educational content;
awarding a continuing education credit based on the elapsed time and pre-determined guidelines set by the professional accrediting authority; and
storing an indication of the awarded credit at a location accessible to the professional accrediting authority.

2. The medium of claim 1 wherein the elapsed time is a time greater than or equal to a minimum time period and less than or equal to a maximum time period.

3. The medium of claim 1 wherein the game is in the form of a question and graphically selectable answer choices.

4. The medium of claim 1 wherein the game is in the form of a plurality of questions and graphically selectable answer choices.

5. The medium of claim 1 wherein the format of the game is customizable by a user.

6. The medium of claim 1 wherein the game is in the form of a crossword puzzle.

7. The medium of claim 1 wherein the instructions further cause the computing device to:
present the user with a daily question over multiple days; and
identify the elapsed time spent answering the daily questions over the multiple days.

8. The medium of claim 1 wherein the instructions further cause the computing device to:
notify the user of the amount of awarded credit.

9. The medium of claim 8 wherein the instructions further cause the computing device to:
present a targeted advertisement to the user at the time of notifying, the targeted advertisement identifying a sponsor of the game.

10. A method for providing educational content through gaming over a network, the method comprising:
providing a page having educational content over the network, the educational content delivered in the form of a playable game, a professional accrediting authority requiring the review of the educational content by a user prior to the professional accrediting authority certifying the compliance of the user with a professional continuing education requirement;
receiving a request for said page from a user;
sending said page to the user;
receiving an identified elapsed time from a computing device to which the page was sent, the identified elapsed time indicating the amount of time the user viewed the educational content;
awarding a continuing education credit based on the elapsed time and pre-determined guidelines set by the professional accrediting authority; and
storing an indication of the awarded credit at a location accessible to the professional accrediting authority.

11. The method of claim 1 wherein the elapsed time is a time greater than or equal to a minimum time period and less than or equal to a maximum time period.

12. The method of claim 10 wherein the game is in the form of a question and graphically selectable answer choices.

13. The method of claim 10 wherein the game is in the form of a plurality of questions and graphically selectable answer choices.

14. The method of claim 10 wherein the format of the game is customizable by a user.

15. The method of claim 10 wherein the game is in the form of a crossword puzzle.

16. The method of claim 10 further comprising:
presenting the user with a daily question over multiple days; and
identifying the elapsed time spent answering the daily questions over the multiple days.

17. The method of claim 10 further comprising:
notifying the user of the amount of awarded credit.

18. The method of claim 17 further comprising:
presenting a targeted advertisement to the user at the time of notifying, the targeted advertisement identifying a sponsor of the game.

19. A computer-readable medium holding computer-executable instructions for providing educational content through gaming over a network, the instructions when executed:
transmitting a page having educational content over the network in response to a received request, the educational content delivered in the form of a playable game, the playable game adjusting a game point total for a user based on correct and incorrect choices respectively made during gameplay, a professional accrediting authority requiring the review of the educational content by a user prior to the professional accrediting authority certifying the compliance of the user with a professional continuing education requirement;
receiving an identified elapsed time from a computing device to which the page was sent, the identified elapsed time indicating the amount of time the user viewed the educational content;
awarding, separately from the game point total, a continuing education credit based on the elapsed time and pre-determined guidelines set by the professional accrediting authority; and
storing an indication of the awarded credit at a location accessible to the professional accrediting authority.

20. The medium of claim 19, wherein the instructions further cause the computing device to:
display in the game a plurality of selectable choices representative of possible answers to a displayed question, the question displayed following presentment to a user of a first portion of the educational content;
receive a selection of one of the plurality of selectable choices;
display a second portion of the educational content in response to the selection.

21. The medium of claim 20 wherein the selection represented a correct answer to the question.

22. The medium of claim 20 wherein the selection represented an incorrect answer to the question, and wherein the instructions further cause the computing device to:
solicit the user for an additional selection after displaying the second portion of the educational content.

23. The medium of claim 22 wherein the second portion of the educational content provides at least one clue to a correct answer and is presented along with information about the selected incorrect answer.

24. The medium of claim 19 wherein the selectable choices are graphically represented as doors.
